(19) United States
(12) Patent Application Publication
(10) Pub. No.: US 2024/0021800 A1
(43) Pub. Date: Jan. 18, 2024

(54) LITHIUM SECONDARY BATTERY

(71) Applicant: SK ON CO., LTD., Seoul (KR)

(72) Inventor: Joo Won KANG, Daejeon (KR)

(21) Appl. No.: 18/349,963

(22) Filed: Jul. 11, 2023

(30) Foreign Application Priority Data
Jul. 18, 2022 (KR) 10-2022-0088405

(51) Int. Cl. H01M 4/36; H01M 10/052

(52) U.S. Cl. CPC H01M 4/366; H01M 10/052; H01M 2004/021

(57) ABSTRACT

A lithium secondary battery includes a cathode including a cathode current collector, an upper cathode active material layer disposed on a top surface of the cathode current collector and a lower cathode active material layer disposed under a bottom surface of the cathode current collector, and an anode facing the cathode. A thickness of the upper cathode active material layer increases in a direction from one end portion to the other end portion of the cathode current collector, and a thickness of the lower cathode active material layer decreases in the direction from the one end portion to the other end portion of the cathode current collector.

### CROSS-REFERENCE TO RELATED APPLICATION AND CLAIM OF PRIORITY

This application claims priority to Korean Patent Application No. 10-2022-0088405 filed on Jul. 18, 2022 in the Korean Intellectual Property Office (KIPO), the entire disclosure of which is incorporated by reference herein.

### BACKGROUND

### 1. Field

The disclosure of this patent document to a lithium secondary battery. More particularly, the present disclosure relates to a lithium secondary battery including a cathode and an anode.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, a hybrid vehicle, etc.

Examples of the secondary battery includes, e.g., a lithium secondary battery, a nickel-cadmium battery, a nickel-hydrogen battery, etc. The lithium secondary battery is being actively developed due to high operational voltage and energy density per unit weight, a high charging rate, a compact dimension, etc.

As an application range of the lithium secondary battery is being expanded, higher rapid charging performance and stability are required.

### SUMMARY

According to an aspect of the present disclosure, there is provided a lithium secondary battery having improved rapid charging performance and stability.

A lithium secondary battery includes a cathode including a cathode current collector, an upper cathode active material layer disposed on a top surface of the cathode current collector and a lower cathode active material layer disposed under a bottom surface of the cathode current collector, and an anode facing the cathode. A thickness of the upper cathode active material layer increases in a direction from one end portion to the other end portion of the cathode current collector, and a thickness of the lower cathode active material layer decreases in the direction from the one end portion to the other end portion of the cathode current collector.

In some embodiments, a ratio of a thickness of the upper cathode active material layer disposed on the other end portion of the cathode current collector relative to a thickness of the upper cathode active material layer disposed on the one end portion of the cathode current collector may be from 1.2 to 1.6. A ratio of a thickness of the lower cathode active material layer disposed under the one end portion of the cathode current collector relative to a thickness of the lower cathode active material layer disposed under the other end portion of the cathode current collector may be from 1.2 to 1.6.

In some embodiments, a sum of thicknesses of the upper cathode active material layer and the lower cathode active material layer may be uniform throughout an entire region of the cathode.

In some embodiments, a slope angle of an extension direction of the cathode current collector with respect to a length direction of the cathode may be from −2.0° to −0.1°.

In some embodiments, the anode may include an anode current collector, an upper anode active material layer disposed on a top surface of the anode current collector, and a lower anode active material layer disposed under a bottom surface of the anode current collector. A thickness of the upper anode active material layer may decrease in a direction from one end portion to the other end portion of the anode current collector, and a thickness of the lower anode active material layer may increase in the direction from one end portion to the other end portion of the anode current collector.

In some embodiments, the one end portion of the anode current collector may overlap the one end of the cathode current collector in a thickness direction, and the other end portion of the anode current collector may overlap the other end portion of the cathode current collector in the thickness direction.

In some embodiments, a sum of a thickness of the lower cathode active material layer disposed under the one end portion of the cathode current collector and a thickness of the upper anode active material layer disposed on the one end portion of the anode current collector may be equal to a sum of a thickness of the upper cathode active material layer disposed on the other end portion of the cathode current collector and a thickness of the lower anode active material layer disposed under the other end portion of the anode current collector.

In some embodiments, a sum of thicknesses of the upper anode active material layer and the lower anode active material layer may be uniform throughout an entire region of the anode.

In some embodiments, a ratio of a thickness of the upper anode active material layer disposed on the one end portion of the anode current collector relative to a thickness of the upper anode active material layer disposed on the other end portion of the anode current collector may be from 1.2 to 1.6. A ratio of a thickness of the lower anode active material layer disposed under the other end portion of the anode current collector relative to a thickness of the lower anode active material layer disposed under the one end portion of the anode current collector may be from 1.2 to 1.6.

In some embodiments, a slope angle of an extension direction of the anode current collector with respect to a length direction of the anode may be from 0.1° to 2.0°.

In some embodiments, the upper cathode active material layer and the lower cathode active material layer may include different types of cathode active materials.

In some embodiments, the lithium secondary battery may have a uniform thickness throughout an entire region.

A lithium secondary battery according to example embodiments includes a cathode and an anode. Cathode active material layers included in the cathode and/or anode active material layers included in the anode may each have a thickness variation or a thickness gradient. Accordingly, an initial heat generation rate during a rapid charging may be increased in a portion having a relatively large thickness of the active material layer. Thus, mobility of lithium ions in an initial stage of the rapid charging may be increased, thereby improving rapid charging performance.

In some embodiments, a total thickness of an upper active material layer and a lower active material layer overlapping in a thickness direction may be uniform throughout an entire region of a corresponding electrode. Accordingly, excessive heat concentration on a specific portion during the rapid charging may be prevented so that stability of the lithium secondary battery may be enhanced.

In some embodiments, a current collector may extend obliquely relative to a length direction of the electrode. Accordingly, the above-described thickness variation or thickness gradient of the active material layer may be implemented while maintaining a uniform thickness of the electrode.

### BRIEF DESCRIPTION OF THE DRAWINGS

FIG. 1 is a schematic cross-sectional view illustrating an electrode stack structure in accordance with example embodiments.

FIG. 2 is a schematic plan view illustrating a lithium secondary battery in accordance with example embodiments.

### DETAILED DESCRIPTION OF THE EMBODIMENTS

According to embodiments of the present disclosure, a lithium secondary battery including a cathode and an anode is provided.

Hereinafter, embodiments of the present inventive concepts will be described in detail with reference to exemplary embodiments and the accompanying drawings. However, those skilled in the art will appreciate that such embodiments and drawings are provided to further understand the spirit of the present invention and do not limit subject matters to be protected as disclosed in the detailed description and appended claims.

The terms “top”, “bottom”, “upper”, “lower”, “one end”, “other end”, etc., used herein are intended to describe the relative positional relationship of elements and do not designate absolute positions.

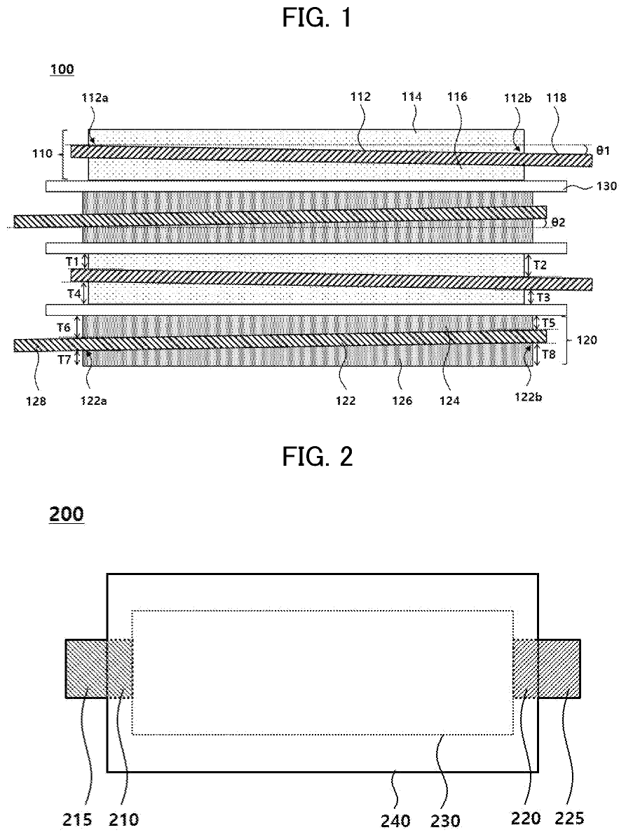

FIG. 1 is a schematic cross-sectional view illustrating an electrode stack structure in accordance with example embodiments.

Referring to FIG. 1, a lithium secondary battery may include a cathode 110 and an anode 120 facing the cathode 110. An electrode stack structure 100 may be formed by alternately and repeatedly stacking the anode 110 and the cathode 120.

In example embodiments, the cathode 110 may include a cathode current collector 112, an upper cathode active material layer 114 and a lower cathode active material layer 116.

For example, the cathode current collector 112 may include stainless steel, nickel, aluminum, titanium, copper, or an alloy thereof. The cathode current collector 112 may include aluminum or stainless steel surface-treated with at least one of carbon, nickel, titanium and silver.

For example, one end portion of the cathode current collector 112 may protrude to form a cathode tab 118. The cathode tab 118 may be connected to a cathode lead. In an embodiment, the cathode current collector 112 and the cathode tab 118 may be integrally formed as a substantially unitary member.

In example embodiments, the upper cathode active material layer 114 may be disposed on a top surface of the cathode current collector 112, and the lower cathode active material layer 116 may be disposed under a bottom surface of the cathode current collector 112.

For example, the upper cathode active material layer 114 and the lower cathode active material layer 116 may each include a cathode active material. For example, the cathode active material may include a compound capable of intercalating and de-intercalating lithium ions.

In some embodiments, the cathode active material may include a lithium-transition metal composite oxide particle having a layered structure or a lithium-metal phosphate particle having an olivine structure.

The lithium-transition metal composite oxide particle may include a layered structure or a chemical structure represented by Chemical Formula 1 below.

LiₓNi_{1-y}M1_{y}O_{2+z} [Chemical Formula 1]

In Chemical Formula 1, 0.9≤x≤1.2, 0≤y≤0.7, and −0.1≤z≤0.1. M1 may include at least one element selected from the group consisting of Na, Mg, Ca, Y, Ti, Hf, V, Nb, Ta, Cr, Mo, W, Mn, Co, Fe, Cu, Ag, Zn, B, Al, Ga, Sn and Zr.

In some embodiments, a molar ratio or concentration (1−y) of Ni in Chemical Formula 1 may be greater than or equal to 0.8, or may exceed 0.8. Accordingly, the cathode active material providing high capacity can be implemented.

The lithium-metal phosphate particle may include an olivine structure or chemical structure represented by Chemical Formula 2 below.

LiₐM2_{b}(PO_{c}) [Chemical Formula 2]

In Chemical Formula 2, 0.9≤a≤1.2, 0.8≤b≤1.2, and 3.8≤c≤4.2. M2 may include at least one element selected from the group consisting of Fe, Mn, Co, Al, Ti and V.

In an embodiment, the lithium-metal phosphate particle may include LiFePO₄.

In some embodiments, the lithium-transition metal composite oxide particle or the lithium-metal phosphate particle may further include a coating element or a doping element. For example, the coating element or doping element may include Al, Ti, Ba, Zr, Si, B, Mg, P, an alloy thereof, or an oxide thereof. These may be used alone or in a combination of two or more therefrom. The cathode active material particle may be passivated by the coating or doping element, so that stability and life-span of the cathode active material may be further improved.

The cathode active material may include a plurality of the lithium-transition metal oxide particles or a plurality of the lithium-metal phosphate particles. For example, an amount of the lithium-transition metal oxide particles or the lithium-metal phosphate particles based on a total weight of the cathode active material may be 50 weight percent (wt %) or more, 60 wt % or more, 70 wt % or more, 80 wt % or more, or 90 wt % or more.

In an embodiment, the cathode active material may substantially consist of the lithium-transition metal oxide particles or the lithium-metal phosphate particles.

In some embodiments, the upper cathode active material layer 114 and the lower cathode active material layer 116 may include different types of cathode active materials.

For example, one of the upper cathode active material layer 114 and the lower cathode active material layer 116 may include the lithium-transition metal composite oxide particle, and the other may include the lithium-metal phosphate particle. For example, the types of cathode active materials may be modified in consideration of stability and capacity properties when forming the cathode.

In some embodiments, the upper cathode active material layer 114 and the lower cathode active material layer 116 may include the same type of the cathode active material.

For example, a rapid charging performance of a lithium secondary battery may be adjusted through a control of heat generation during charging. For example, mobility of lithium ions may be increased by inducing an initial heat generation during a rapid charging. Accordingly, the rapid charging performance of the lithium secondary battery may be improved.

According to example embodiments of the present disclosure, a thickness of the upper cathode active material layer 114 increases in a direction from one end portion 112a to the other end portion 112b of the cathode current collector, and a thickness of the lower cathode active material layer 116 decreases in the direction from one end portion 112a to the other end portion 112b of the cathode current collector.

Accordingly, an initial heat generation rate during the rapid charging may be increased in a portion having a relatively large thickness among the cathode active material layers 114 and 116. Thus, mobility of lithium ions in an initial stage of the rapid charging may be increased, thereby improving the rapid charging performance.

In some embodiments, a ratio T2/T1 of a thickness T2 of the upper cathode active material layer disposed on the other end portion 112b of the cathode current collector relative to a thickness T1 of the upper cathode active material layer 114 disposed on one end portion 112a of the cathode current collector may be from 1.2 to 1.6.

In some embodiments, a ratio T4/T3 of a thickness T4 of the lower cathode active material layer 116 disposed under one end portion 112a of the cathode current collector relative to a thickness T3 of the lower cathode active material layer 116 disposed under the other end portion 112b of the cathode current collector may be from 1.2 to 1.6.

Within the above thickness ratio range, degradation of stability due to an excessive concentration of the initial heat generated in a partial region of the cathode active material layers 114 and 116 may be prevented while sufficiently improving the rapid charging performance.

In some embodiments, a total thickness of the upper cathode active material layer 114 and the lower cathode active material layer 116 may be uniform throughout an entire area of the cathode 110. For example, a sum of the thicknesses of the upper cathode active material layer 114 and the lower cathode active material layer 116 at any point of the cathode current collector may be uniform throughout the entire area of the cathode 110.

The term “thickness direction” used herein refers to a direction in which the cathode 110 and the anode 120 are stacked in the electrode stack structure 100.

Accordingly, the excessive heat concentration at a specific portion may be prevented during the rapid charging, and stability of the lithium secondary battery may be improved.

The terms “uniform”, “identical” or “substantially the same” used herein includes cases that are mathematically completely identical and cases that are similar enough to be regarded as substantially the same.

In some embodiments, the cathode current collector 112 may extend obliquely with respect to a length direction of the cathode 110.

The term “length direction” used herein refers to a direction perpendicular to the thickness direction and may indicate a direction in which the cathode 110 and/or the anode 120 extend. The length direction may refer to a direction in which the separator 130 extends in FIG. 1.

In some embodiments, a slope angle θ1 of an extension direction of the cathode current collector 112 with respect to the length direction of the cathode 110 may be in a range from −2.0° to −0.1°. Within the above slope angle range, the thickness deviation of the cathode active material layers 114 and 116 may be implemented while forming the cathode 110 with a uniform thickness.

In an embodiment, the slope angle θ1 of the extension direction of the cathode current collector 112 may be constant throughout the entire cathode current collector 112.

For example, a cathode mixture may be prepared by mixing and stirring the above-described cathode active material in a solvent with a binder, a conductive material, a dispersive agent, etc. The cathode mixture may be coated on the top and bottom surfaces of the cathode current collector 112, and then dried and pressed to form the cathode 110 including the cathode active material layers 114 and 116.

A non-aqueous solvent such as N-methyl-2-pyrrolidone (NMP), dimethylformamide, dimethylacetamide, N,N-dimethylaminopropylamine, ethylene oxide and tetrahydrofuran may be used as the solvent.

For example, the binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

In an embodiment, a PVDF-based binder may be used as a cathode binder. In this case, an amount of the binder for forming the cathode active material layers 114 and 116 may be reduced, and an amount of the cathode active material may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

In example embodiments, the lithium secondary battery may include the anode 120 facing the cathode 110.

In some embodiments, the anode 120 may include an anode current collector 122, an upper anode active material layer 124 and a lower anode active material layer 126.

For example, the anode current collector 122 may include copper, stainless steel, nickel, titanium, or an alloy thereof. The anode current collector 122 may include copper or stainless steel surface-treated with carbon, nickel, titanium or silver.

For example, one end portion of the anode current collector 122 may protrude to form an anode tab 128. The anode tab 128 may be connected to an anode lead. In an embodiment, the anode current collector 122 and the anode tab 128 may be integrally formed as a substantially unitary member.

In some embodiments, the cathode tab 118 and the anode tab 128 may not overlap in the thickness direction. For example, the cathode tab 118 and the anode tab 128 may be formed at opposite sides of the cathode 110 or the lithium secondary battery in the length direction.

In example embodiments, the upper anode active material layer 124 may be disposed on a top surface of the anode current collector 122, and the lower anode active material layer 126 may be disposed under a bottom surface of the anode current collector 122.

For example, the upper anode active material layer 124 and the lower anode active material layer 126 may each include an anode material. For example, the anode active material may include a material capable of intercalating and de-intercalating lithium ions.

The anode active material may include a carbon-based material such as a crystalline carbon, an amorphous carbon, a carbon complex or a carbon fiber, a lithium alloy, a silicon-based material, a carbon-silicon composite, etc.

The amorphous carbon may include a hard carbon, cokes, a mesocarbon microbead (MCMB) fired at a temperature of 1500° C. or less, a mesophase pitch-based carbon fiber (MPCF), etc. The crystalline carbon may include a graphite-based material such as natural graphite, graphitized cokes, graphitized MCMB, graphitized MPCF, etc.

The lithium alloy may further include aluminum, zinc, bismuth, cadmium, antimony, silicon, lead, tin, gallium, indium, etc.

For example, the carbon-silicon composite may include a composite particle in which silicon is coated on an inner surface of pores or an outer surface of a porous carbon-based particle.

In some embodiments, the upper anode active material layer 124 and the lower anode active material layer 126 may include different types of anode active materials.

In some embodiments, the upper anode active material layer 124 and the lower anode active material layer 126 may include the same type of the anode active material.

In some embodiments, a thickness of the upper anode active material layer 124 may decrease in a direction from one end portion 122a to the other end portion 122b of the anode current collector, and a thickness of the lower anode active material layer 126 may increase in a direction from one end portion 122a to the other end portion 122b of the anode current collector.

Accordingly, an initial heat generation rate during the rapid charging may be increased at a portion having a relatively large thickness among the anode active material layers 124 and 126. Thus, mobility of lithium ions in the initial stage of the rapid charging may be increased, thereby improving the rapid charging performance.

In some embodiments, a ratio T6/T5 of a thickness T6 of the upper anode material layer disposed on one end portion 122a of the anode current collector relative to a thickness T5 of the upper cathode active material layer 124 disposed on the other end portion 122b of the anode current collector may be from 1.2 to 1.6.

In some embodiments, a ratio T8/T7 of a thickness T8 of the lower anode active material layer 126 disposed under the other end portion 122b of the anode current collector relative to a thickness T7 of the lower anode active material layer 126 disposed under one end portion 122a of the anode current collector may be from 1.2 to 1.6.

Within the above thickness ratio range, degradation of stability due to an excessive concentration of the initial heat generated in a partial region of the anode active material layers 124 and 126 may be prevented while sufficiently improving the rapid charging performance.

In some embodiments, one end portion 122a of the anode current collector may overlap one end portion 112a of the cathode current collector in the thickness direction, and the other end portion 122b of the anode current collector may overlap the other end portion of the cathode current collector 112b in the thickness direction.

Accordingly, as illustrated in FIG. 1, portions of the cathode active material layers 114 and 116 having a relatively large thickness may overlap portions of the anode active material layers 124 and 126 having a relatively large thickness in the thickness direction. Portions of the cathode active material layers 114 and 116 having a relatively small thickness may overlap portions of the anode active material layers 124 and 126 having a relatively small thickness in the thickness direction.

Accordingly, the initial heat generation rate may be further increased during the rapid charging. Further, a reversible capacity ratio and an electrode capacity ratio of the cathode 110 and the anode 120 may become uniform over the entire region of the electrode stack structure 100 or the lithium secondary battery. Thus, driving stability of the lithium secondary battery may be improved.

For example, the reversible capacity ratio refers to an amount of lithium ions transferred from the anode to the cathode during discharging (e.g., a charge capacity) relative to an amount of lithium ions transferred from the cathode to the anode during charging (e.g., a discharge capacity).

In some embodiments, a total thickness of the lower cathode active material layer 116 disposed under one end portion 112a of the cathode current collector and the upper anode active material layer 124 disposed on one end portion 122a of the anode current collector may be equal to a total thickness of the upper cathode active material layer 114 disposed on the other end portion 112b of the cathode current collector and the lower anode active material layer 126 disposed under the other end portion 122b of the anode current collector.

Accordingly, the entire thickness of the electrode stack structure 100 may be substantially uniform. Thus, mechanical stability may be maintained or improved while improving the rapid charging properties of the lithium secondary battery.

In some embodiments, the total thickness of the upper anode active material layer 124 and the lower anode active material layer 126 may be substantially uniform throughout an entire region of the anode 120. For example, a sum of the thicknesses of the upper anode active material layer 124 and the lower anode active material layer 126 at any point of the anode current collector 122 may be substantially uniform throughout the entire region of the anode 120.

Accordingly, an excessive concentration of heat at a specific region during the rapid charging may be prevented to improve stability of the lithium secondary battery.

In some embodiments, the anode current collector 122 may extend obliquely with respect to the length direction of the anode 120.

In some embodiments, a slope angle θ2 of an extension direction of the anode current collector 122 with respect to the length direction of the anode 120 may range from 0.1° to 2.0°. Within the above slope angle range, the thickness deviation of the cathode active material layers 124 and 126 may be implemented while forming the cathode 120 with a uniform thickness.

In an embodiment, the slope angle θ2 of the extension direction of the anode current collector 122 may be constant throughout the entire anode current collector 122.

In an embodiment, a sum of the slope angle θ1 of the extension direction of the cathode current collector 112 with respect to the length direction of the cathode 110 and the slope angle θ2 of the extension direction of the anode current collector 122 with respect to the length direction of the anode 120 may be from −0.1° to 0.1°, preferably 0. Accordingly, the thickness of the electrode stacked structure 100 may be entirely uniform, and stability of the lithium secondary battery may be improved.

For example, the electrode capacity ratio (C/A ratio) may be a cathode capacity relative to an anode capacity of the lithium secondary battery. For example, the anode capacity may be proportional to the thickness of the anode active material layer, and the cathode capacity may be proportional to the thickness of the cathode active material layer. If the electrode capacity ratio is locally different in the electrode, lithium may be precipitated in a portion having a relatively high electrode capacity ratio to deteriorate stability of the lithium secondary battery.

In some embodiments, the lithium secondary battery may have a uniform thickness throughout an entire region. Accordingly, the electrode capacity ratio of the lithium secondary battery may be constant throughout the entire region. Thus, stability of the lithium secondary battery may be improved.

For example, an anode mixture may be prepared by mixing and stirring the anode active material with a binder, a conductive material, a thickener and/or a dispersive agent in a solvent. The anode mixture may be coated on the top and bottom surfaces of the anode current collector, and then dried and pressed to form the anode 120 including the anode active material layers 124 and 126.

For example, the solvent included in the anode mixture may include an aqueous solvent such as water, an aqueous hydrochloric acid solution or an aqueous sodium hydroxide solution.

For example, the anode binder may include a polymer material such as styrene-butadiene rubber (SBR). The thickener may include carboxylmethyl cellulose (CMC).

For example, the conductive material substantially the same as or similar to those used for the cathode active material layers 114 and 116 may be used in the anode.

In some embodiments, the electrode stack structure 100 may further include a separator 130 disposed between the anode 110 and the cathode 120.

The separator 130 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separator 130 may also include a non-woven fabric formed from a glass fiber with a high melting point, a polyethylene terephthalate fiber, or the like.

In some embodiments, the anode 120 may have a larger area (e.g., contact area with the separator 130) and/or a larger volume than that of the cathode 110. Accordingly, lithium ions generated from the cathode 110 may be easily transferred to the anode 120 without being precipitated.

FIG. 2 is a schematic plan view illustrating a lithium secondary battery in accordance with example embodiments.

Referring to FIG. 2, the lithium secondary battery 200 includes an electrode assembly 230, a case 240 in which the electrode assembly 230 is accommodated, and electrode tab portions 210 and 220 formed by fusion of electrode tabs 118 and 128, and electrode leads 215 and 225.

For example, an electrode cell may be defined by the cathode 110, the anode 120 and the separator 140, and a plurality of the electrode cells may be stacked to form the above-described electrode stack structure 100. For example, the electrode stack structure 100 may be wound, stacked or folded to form the electrode assembly having a jelly-roll shape using winding, stacking or folding of the separator 130.

The electrode assembly 230 may be accommodated together with an electrolyte in the case 240 to define the lithium secondary battery. In example embodiments, a non-aqueous electrolyte may be used as the electrolyte.

The non-aqueous electrolyte may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

For example, the cathode tab 118 and the anode tab 128 may protrude from the cathode current collector 112 and the anode current collector 122, respectively.

As illustrated in FIG. 2, the cathode tabs may be fused to form the cathode tab portion 210 that may extend to one side of the case 240. The anode tabs 128 may be fused to form the anode tab portion 220 that may extend to the other side of the case 240. The electrode tab portions 210 and 220 may be fused together with one side and the other side of the case 240, and the electrode lead (the cathode lead 215 and the anode lead 225) extended or exposed to an outside of the case 240 may be formed.

The lithium secondary battery may be manufactured in, e.g., a cylindrical shape using a can, a square shape, a pouch shape or a coin shape.

Hereinafter, preferred embodiments are proposed to more concretely describe the present disclosure. However, the following examples are only given for illustrating the present invention and those skilled in the related art will obviously understand that various alterations and modifications are possible within the scope and spirit of the present invention. Such alterations and modifications are duly included in the appended claims.

### Example 1

(1) Fabrication of Cathode

LiFePO₄ particles were used as a cathode active material.

A cathode mixture was prepared by mixing the cathode active material, Denka Black as a conductive material and PVDF as a binder in a mass ratio of 97:2:1, respectively.

The cathode mixture was coated on a top surface of an aluminum current collector so that a thickness increased from one end portion to the other end portion of the aluminum current collector, and then dried and pressed to prepare an upper cathode active material layer.

The cathode mixture was coated under a bottom surface of the aluminum current collector so that a thickness decreased from one end portion to the other end portion of the aluminum current collector, and then dried and pressed to prepare a lower cathode active material layer.

A ratio of the thickness of the upper cathode active material layer disposed on the other end portion to the thickness of the upper cathode active material layer disposed on the one end portion of the aluminum current collector, and a ratio of the thickness of the lower cathode active material layer disposed under the one end portion to the thickness of the lower cathode active material layer disposed under the other end portion were as shown in Table 1.

The cathode was manufactured such that a slope angle of the aluminum current collector relative to an extension direction of the cathode was as shown in Table 1.

(2) Fabrication of Anode

An anode slurry including 93 wt % of natural graphite as an anode active material, 5 wt % of KS6 as a flake type conductive material, 1 wt % of styrene-butadiene rubber (SBR) as a binder, and 1 wt % of carboxymethyl cellulose (CMC) as a thickener was prepared. The anode slurry was coated on top and bottom surfaces of a copper current collector, and dried and pressed to prepare an upper anode active material layer and a lower anode active material layer.

A thickness of each of the upper and lower anode active material layers was entirely uniform.

The anode was manufactured such that a slope angle of the copper current collector relative to an extension direction of the anode was as shown in Table 1.

(3) Fabrication of Lithium Secondary Battery

The cathode and the anode prepared as described above were each notched by a predetermined size, and stacked with a separator (polyethylene, thickness: 25 μm) interposed therebetween to form an electrode cell. Each tab portion of the cathode and the anode was welded. The welded cathode/separator/anode assembly was inserted in a pouch, and three sides of the pouch except for an electrolyte injection side were sealed. The tab portions were also included in sealed portions. An electrolyte was injected through the electrolyte injection side, and then the electrolyte injection side was also sealed. Subsequently, the above structure was impregnated for 12 hours or more.

The electrolyte was prepared by forming 1M LiPF₆ solution in a mixed solvent of ethylene carbonate (EC)/ethyl methyl carbonate (EMC)/diethylene carbonate (DEC) (25/45/30; volume ratio), and then adding 1 wt % of vinylene carbonate, 0.5 wt % of 1,3-propensultone (PRS) and 0.5 wt % of lithium bis(oxalato)borate (LiBOB).

The secondary battery prepared as described above was pre-charged for 36 minutes at a current (5 A) corresponding to 0.25C. Degasing was performed after 1 hour, aged for more than 24 hours, and then formation charging and discharging were performed (charging condition: CC-CV 0.2C 4.2V 0.05C CUT-OFF, discharging condition: CC 0.2C 2.5V CUT-OFF).

### Example 2

The prepared anode slurry was coated on the top surface of the copper current collector so that a thickness decreased from one end portion to the other end portion of the copper current collector, and then dried and pressed to form an upper anode active material layer.

The prepared anode slurry was coated on the bottom surface of the copper current collector so that a thickness increased from the one end portion to the other end portion of the copper current collector, and then dried and pressed to form a lower anode active material layer.

A ratio of the thickness of the upper anode active material layer disposed on the one end portion to the thickness of the upper cathode active material layer disposed on the other end portion of the copper current collector, and a ratio of the thickness of the lower anode active material layer disposed under the other end portion to the thickness of the lower anode electrode active material layer disposed under the one end portion were as shown in Table 1.

A lithium secondary battery was manufactured by the same method as that in Example 1 except for the above details.

### Examples 3 and 4

A lithium secondary battery was manufactured by the same manner as that in Example 2, except that the thickness ratio of the upper and lower cathode active material layers and the ratio of thicknesses of the upper and lower anode active material layers were as shown in Table 1.

### Example 5

A lithium secondary battery was manufactured by the same method as that in Example 2, except that LiFePO₄ particles were used as a cathode active material in the upper cathode active material layer used and LiNi_{0.8}Co_{0.1}Mn_{0.1}O₂ particles were used as a cathode active material in the lower cathode active material layer.

### Comparative Example 1

A lithium secondary battery was manufactured by the same method as that in Example 1, except that the thicknesses of the upper and lower cathode active material layers were entirely uniform.

### Comparative Example 2

In the fabrication of the cathode, the cathode mixture was coated on the top surface of the aluminum current collector such that the thickness increased from one end portion to the other end portion of the aluminum current collector, and then dried and pressed to form an upper cathode active material layer.

The cathode mixture was coated under the bottom surface of the aluminum current collector such that the thickness increased from the one end portion to the other end portion of the aluminum current collector, and then dried and presses to form a lower cathode active material layer. The upper and lower cathode active material layers were formed symmetrically with the aluminum current collector interposed therebetween.

Except for the above details, a lithium secondary battery was manufactured by the same method as that in Example 1.

Table 1 below shows the thickness ratios of the cathode active material layers and the anode active material layers and the slope angle of the extension direction of the current collector with respect to the length direction of the electrode in the above-described Examples and Comparative Examples.

TABLE 1

| | thickness ratio of active material layer | | | | | |
|---|---|---|---|---|---|---|
| | upper | lower | upper | lower | slope angle of active | |
| | cathode | cathode | anode | anode | material layer (°) | |
| | active | active | active | active | cathode | anode |
| | material | material | material | material | current | current |
| | layer | layer | layer | layer | collector | collector |
| Example 1 | 1.4 | 1.4 | 1 | 1 | −1.0 | 0 |
| Example 2 | 1.4 | 1.4 | 1.4 | 1.4 | −1.0 | 1.0 |
| Example 3 | 1.1 | 1.1 | 1.1 | 1.1 | −0.08 | 0.08 |
| Example 4 | 1.65 | 1.65 | 1.65 | 1.65 | −2.1 | 2.1 |
| Example 5 | 1.4 | 1.4 | 1.4 | 1.4 | −1.0 | 1.0 |
| Comparative | 1 | 1 | 1 | 1 | 0 | 0 |
| Example 1 | | | | | | |
| Comparative | 1.4 | 0.714 | 1 | 1 | 0 | 0 |
| Example 2 | | | | | | |

### Experimental Example

(1) Evaluation on Charging Properties by Rate During Rapid Charging

A first charge (CC/CV 0.2C 4.2V 0.05C CUT-OFF) and a discharge (CC 0.2C 2.5V CUT-OFF) were performed for the lithium secondary battery manufactured according to each of Examples and Comparative Examples. Thereafter, a second charge (CC/CV xC 4.2V 0.05C CUT-OFF) was performed.

In the second charge, x was 0.2C, 0.333C, 0.5C, 0.7C, 1.0C, 1.2C, 1.5C, 1.7C, 2.0C, and the second charge was performed in a chamber maintained at room temperature (25° C.).

A constant current section charge capacity (%) for each charging rate with respect to an initial 0.2C constant current charge capacity was measured.

(2) Evaluation on Rapid Charge Life-Span Property

The lithium secondary battery manufactured according to each of Examples and Comparative Examples was charged by a stepped charge method using C-rates of 2.0C/1.75C/1.5C/1.25C/1.0C/0.75C/0.5C to reach a DOD72 state within 25 minutes, and then discharged by ⅓C. The rapid charging evaluation was performed by repeating the charging and discharging cycle as one cycle. After repeating 100 cycles with an interphase of 10 minutes between the charge and discharge cycles, a rapid charge capacity retention was measured.

The evaluation results are shown in Table 2 and Table 3 below.

TABLE 2

| | constant current charging section capacity (%) | | | | | | | | |
|---|---|---|---|---|---|---|---|---|---|
| | 0.2 C | 0.333 C | 0.5 C | 0.7 C | 1.0 C | 1.2 C | 1.5 C | 1.7 C | 2.0 C |
| Example 1 | 100.0 | 96.9 | 90.8 | 86.1 | 81.4 | 79.3 | 77.2 | 74.3 | 69.3 |
| Example 2 | 100.0 | 98.1 | 91.7 | 87.0 | 83.1 | 80.2 | 78.3 | 74.8 | 70.9 |
| Example 3 | 100.0 | 97.4 | 91.1 | 86.2 | 82.0 | 79.7 | 77.8 | 74.5 | 70.3 |
| Example 4 | 100.0 | 98.2 | 91.8 | 87.2 | 83.2 | 80.3 | 78.5 | 74.7 | 71.1 |
| Example 5 | 100.0 | 97.9 | 91.5 | 86.9 | 83.0 | 80.0 | 78.1 | 74.5 | 70.7 |
| Comparative | 100.0 | 95.9 | 89.2 | 84.3 | 80.8 | 78.9 | 76.5 | 72.9 | 67.6 |
| Example 1 | | | | | | | | | |
| Comparative | 100.0 | 96.7 | 90.6 | 85.9 | 81.2 | 79.1 | 77.0 | 74.0 | 68.9 |
| Example 2 | | | | | | | | | |

TABLE 3

| | rapid charge capacity retention |
|---|---|
| | (100 cycles, %) |
| Example 1 | 97.0 |
| Example 2 | 98.6 |
| Example 3 | 98.3 |
| Example 4 | 97.1 |
| Example 5 | 98.4 |
| Comparative Example 1 | 96.2 |
| Comparative Example 2 | 96.3 |

Referring to Tables 2 and 3, in Examples where the cathode active material layer was formed with changing the thickness thereof, overall rapid charging properties and capacity retention were improved compared to those from Comparative Examples.

In Example, where the thickness ratio of the cathode active material layers and the thickness ratio of the anode active material layers were less than 1.2, the rapid charging properties were relatively lowered compared to those from other Examples.

In Example 4 where the thickness ratio of the cathode active material layer and the thickness ratio of the anode active material layer exceeded 1.6, the capacity retention was relatively lowered compared to those from other Examples.

In Comparative Example 2 where the cathode active material layers were formed symmetrically, heat generation was excessively concentrated to deteriorate the rapid charging and life-span properties.

What is claimed is:

1. A lithium secondary battery, comprising:
a cathode comprising a cathode current collector, an upper cathode active material layer disposed on a top surface of the cathode current collector, and a lower cathode active material layer disposed under a bottom surface of the cathode current collector; and
an anode facing the cathode,
wherein a thickness of the upper cathode active material layer increases in a direction from one end portion to the other end portion of the cathode current collector, and a thickness of the lower cathode active material layer decreases in the direction from the one end portion to the other end portion of the cathode current collector.

2. The lithium secondary battery of claim 1, wherein a ratio of a thickness of the upper cathode active material layer disposed on the other end portion of the cathode current collector relative to a thickness of the upper cathode active material layer disposed on the one end portion of the cathode current collector is from 1.2 to 1.6, and
a ratio of a thickness of the lower cathode active material layer disposed under the one end portion of the cathode current collector relative to a thickness of the lower cathode active material layer disposed under the other end portion of the cathode current collector is from 1.2 to 1.6.

3. The lithium secondary battery of claim 1, wherein a sum of thicknesses of the upper cathode active material layer and the lower cathode active material layer is uniform throughout an entire region of the cathode.

4. The lithium secondary battery of claim 1, wherein a slope angle of an extension direction of the cathode current collector with respect to a length direction of the cathode is from −2.0° to −0.1°.

5. The lithium secondary battery of claim 1, wherein the anode comprises an anode current collector, an upper anode active material layer disposed on a top surface of the anode current collector, and a lower anode active material layer disposed under a bottom surface of the anode current collector, and
a thickness of the upper anode active material layer decreases in a direction from one end portion to the other end portion of the anode current collector, and a thickness of the lower anode active material layer increases in the direction from one end portion to the other end portion of the anode current collector.

6. The lithium secondary battery of claim 5, wherein the one end portion of the anode current collector overlaps the one end of the cathode current collector in a thickness direction, and the other end portion of the anode current collector overlaps the other end portion of the cathode current collector in the thickness direction.

7. The lithium secondary battery of claim 5, wherein a sum of a thickness of the lower cathode active material layer disposed under the one end portion of the cathode current collector and a thickness of the upper anode active material layer disposed on the one end portion of the anode current collector is equal to a sum of a thickness of the upper cathode active material layer disposed on the other end portion of the cathode current collector and a thickness of the lower anode active material layer disposed under the other end portion of the anode current collector.

8. The lithium secondary battery of claim 5, wherein a sum of thicknesses of the upper anode active material layer and the lower anode active material layer is uniform throughout an entire region of the anode.

9. The lithium secondary battery of claim 5, wherein a ratio of a thickness of the upper anode active material layer disposed on the one end portion of the anode current collector relative to a thickness of the upper anode active material layer disposed on the other end portion of the anode current collector is from 1.2 to 1.6, and
a ratio of a thickness of the lower anode active material layer disposed under the other end portion of the anode current collector relative to a thickness of the lower anode active material layer disposed under the one end portion of the anode current collector is from 1.2 to 1.6.

10. The lithium secondary battery of claim 5, wherein a slope angle of an extension direction of the anode current collector with respect to a length direction of the anode is from 0.10 to 2.0°.

11. The lithium secondary battery of claim 1, wherein the upper cathode active material layer and the lower cathode active material layer include different types of cathode active materials.

12. The lithium secondary battery according to claim 1, wherein the lithium secondary battery has a uniform thickness throughout an entire region.
